(19) United States
(12) Patent Application Publication
(10) Pub. No.: US 2018/0043611 A1
(43) Pub. Date: Feb. 15, 2018

(54) METHOD AND SYSTEM FOR MANUFACTURE OF 3D MULTI-COLORED OBJECTS

(71) Applicant: MASSIVIT 3D PRINTING TECHNOLOGIES LTD, Lod (IL)

(72) Inventor: Itzhak Taff, Yavne (IL)

(73) Assignee: MASSIVIT 3D PRINTING TECHNOLOGIES LTD, Lod (IL)

(21) Appl. No.: 15/556,614

(22) PCT Filed: Mar. 13, 2016
(86) PCT No.: PCT/IL16/50276

§ 371 Date: Sep. 8, 2017

Related U.S. Application Data
(60) Provisional application No. 62/137,839, filed on Mar. 25, 2015.

(51) Int. Cl. B29C 64/106; B29C 64/321; B33Y 10/00; B33Y 30/00; B29C 64/209; B29C 64/227

(52) U.S. Cl. CPC B29C 64/106; B29C 64/209; B29C 64/227; B33Y 10/00; B33Y 30/00; B29C 64/321; B29K 2105/0032

(57) ABSTRACT

A system for manufacture of a multi-colored three-dimensional object, comprising at least one tank configured to store a colorless pseudoplastic material at atmospheric pressure, at least one bidirectional pump, an extrusion nozzle having at least one opening and configured to draw thereinto at least a quantity of the color materials and/or colorless pseudoplastic material and extrude in image-wise manner the drawn material and a X-Y-Z movement system configured to move at least the extrusion nozzle in a three coordinate system wherein the extrusion nozzle draws and extrudes the pseudoplastic material through the same opening.

### TECHNOLOGY FIELD

The apparatus and method are related to the field of additive manufacturing and particularly to additive manufacturing devices.

### BACKGROUND

Three dimensional objects manufacturing process includes deposition of a resin layer, imaging of the layer and curing or hardening of the imaged segments of the layer. The layers are deposited (added) on top of each other and because of it the process is called additive manufacturing process by means of which a computer generated 3D models is converted into a physical object. The process involves generation of a plurality of material layers of different or identical shape. The layers are laid down or deposited on top (or bottom) of each of the preceding layer until the amount of layers results in a desired three dimensional physical object.

The material from which the layers of the three-dimensional physical object are generated could come in liquid, paste, powder, gel and other forms. Conversion of such materials into a solid form is typically performed by suitable actinic radiation or heat.

Most objects manufactured today by additive processing are of uniform (monochromatic) color, their color commonly being the original color of the resin. Increasing demand for multi-color objects has led to various attempts to color the manufactured object most of which involve either post-manufacturing painting or employment of pre-colored resin filaments and alternating between the filaments as desired. However such suggested solutions can increase costs of manufacture due to the materials themselves being expensive, be time consuming and/or slow down throughput time requiring manual labor in case of hand painting the finished object or stopping mid-process to change pre-colored filaments.

Manufacturing of 3D multi-coloreds spans over a large range of applications. This includes prototype manufacture, small runs of different products manufacture, decorations, sculptures, architectural models, and other physical objects.

One obstacle experienced in the current multi-color or variable material 3D additive manufacturing is in the need of cleaning the extrusion head and/or nozzle after or before any change of material to be deposited. This process can be time consuming and costly.

It is the purpose of this disclosure to provide apparatus, methods and materials that support faster, lower cost and automatic manufacturing of multi-colored three-dimensional objects.

### SUMMARY

The current three-dimensional multi-colored object manufacturing system and technique relies on online deposition of a pigmented and non-pigmented pseudoplastic material in gel aggregate state. The gel flows through a deposition nozzle because the applied agitation shears the bonds and breakdown in the elasticity of the fluid. The elasticity recovers immediately after leaving the nozzle, and the gel solidifies under curing energy to maintain its shape and strength.

In one example, a three-dimensional multi-colored object manufacturing system can include one or more delivery tubing that deliver pigmented pseudoplastic material in gel aggregate state from one or more dedicated storage or material supply tanks into extrusion head nozzle to be deposited for manufacturing a 3D multi-colored object.

In another example, three-dimensional multi-colored object manufacturing system can include a bidirectional pump configured to supply colorless pseudoplastic material in gel aggregate state and to allow colored pseudoplastic material or gel to be drawn directly into the system extrusion head via an extrusion head nozzle opening to be later deposited via the same opening for manufacturing a 3D multi-colored object.

### LIST OF FIGURES AND THEIR DESCRIPTION

FIG. 1 which is a partial plan view and block diagram simplified illustration of an example of a system suitable for manufacture of a multi-colored three-dimensional object in accordance with an example;

FIG. 2 is a partial plan view and block diagram simplified illustration of system suitable for manufacture of a multi-colored three-dimensional multi-color object in accordance with another example;

FIG. 3 is a partial plan view and block diagram simplified illustration of a system suitable for manufacture of a multi-colored three-dimensional multi-color object in accordance with yet another example;

FIGS. 4A, 4B, 4C and 4D collectively referred to as FIG. 4, depict the implementation of the system suitable for manufacture of a multi-colored three-dimensional multi-color object of FIG. 3;

FIG. 5 is a plan view simplified illustration of a dispensed 3D object in accordance with still another example; and

FIG. 6 is a plan view simplified illustration of a partially dispensed 3D object in accordance with another example.

### DESCRIPTION

The term “Colorless” as used in this disclosure means the color of a material in its “natural” post-manufacturing state resulting solely from its method of manufacture and having no color-producing additives.

One three-dimensional object manufacturing technique relies on the deposition of material in gel aggregate state. The gel flows through an extrusion or deposition nozzle because the applied agitation and pressure shears the inter-particle bonds and induces a breakdown in the elasticity of the material. The material recovers immediately after leaving the nozzle, and the gel almost solidifies to maintain its shape.

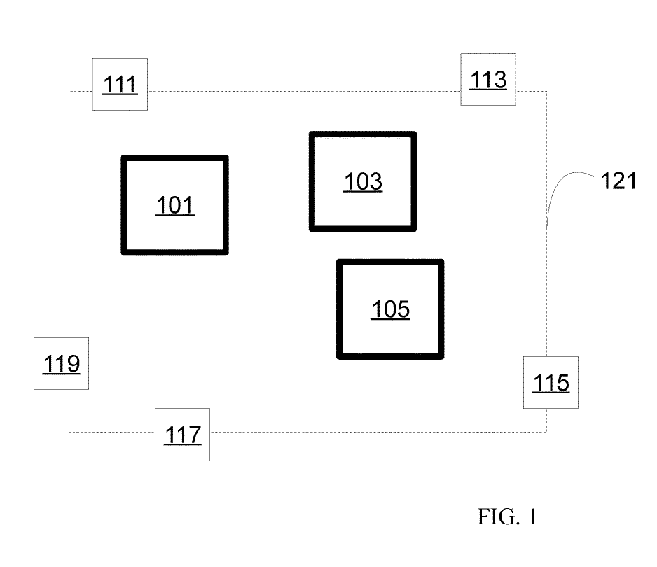

Reference is made to FIG. 1 which is a partial plan view and block diagram simplified illustration of an example of a system suitable for manufacture of a multi-colored three-dimensional objects or structures in accordance with an example. System 100 can include a storage or material supply tank 102 adapted to store a colorless resin, material, liquid or gel such as, for example, a pseudoplastic high viscosity material 104. Material supply tank also could include an agitator-pump 108 configured to agitate and shear thin the pseudoplastic high viscosity material or gel 104, to reduce material 104 viscosity to cause the material to flow.

Agitator-pump 108 could be such as Graco S20 supply system commercially available from Graco Minneapolis, Minn. U.S.A., or a barrel follower dispensing pump Series 90 commercially available from Scheugenpflug AG93333 Neustadt a.d.Donau Germany. Agitator-pump 108 in addition to agitation also develops a pressure higher than atmospheric pressure such that the pseudoplastic material 104 flows through a delivery tubing or system 112 to extrusion (head) 114 and extruded or deposited via an opening in nozzle 116.

System 100 can include an X-Y-Z movement system 124 configured to move the extrusion nozzle 116 in a three coordinate system. Alternatively, a table 120 could be made to move in a three coordinate system. In another example, the movement in three directions (X-Y-Z) could be divided between the extrusion nozzle 116 and table 120. System 100 also includes a computer 128 configured to control operation of movement system 124, agitator-pump 108 pseudoplastic material steering operation and value or magnitude of the pressure higher than atmospheric pressure. Computer 128 is further adapted to receive the three-dimensional (3D) object 132 data and generate from the received data the X-Y-Z movement commands and distance such that the pseudoplastic material 104 is extruded through extrusion (head) nozzle 116 opening in an image wise manner. The X-Y-Z movement could be performed in a vector mode, depending on the object to be printed. Computer 128 could also be configured to optimize the decision on the printing mode.

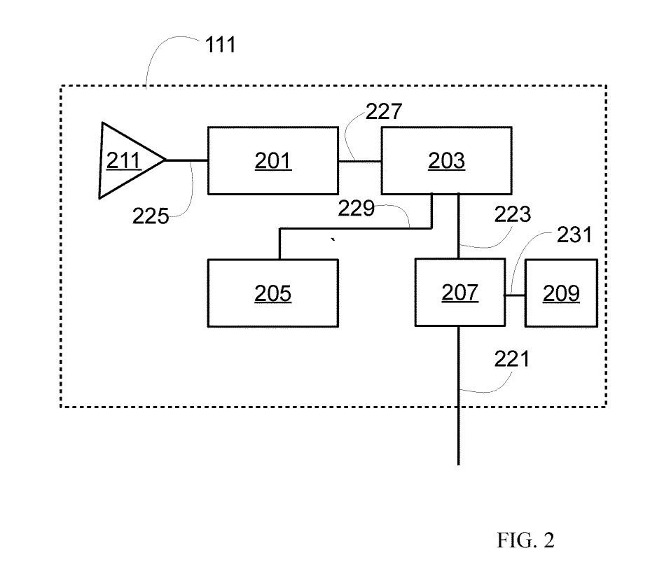

System 100 can further include a source of radiation 136. Source of radiation 136 could be such as FireJet FJ200commercially available from Phoseon Technology, Inc., Hillsboro Oreg. 97124 USA. Source of radiation 136 provides UV radiation with total UV power of up to 900W and wavelength range of 380-420 nm. Alternatively, a UV lamp such as for example, mercury vapor lamp model Shot 500 commercially available from CureUV, Inc., Delray Beach, Fla. 33445 USA. Source of radiation 136 operates in a continuous manner and the radiation is selected to harden the pseudoplastic material 104. Computer 128 could also be configured to control operation of source of radiation 136 and synchronize it with the printing mode. In the remaining FIGS. 2-4, source of radiation 136 has been removed for clarity of explanation.

Extrusion nozzle 116 can include a reception volume 202 defined in FIG. 2 by a phantom line border, which communicates with a volume 204 inside extrusion head 114 narrows towards and opens to nozzle 116. Reception volume 202 can receive material 104 pumped into extrusion head 114 volume 204 by agitator-pump 108 and dispense received material 104 through nozzle 116. Reception volume 202 can be coated with a material such as, for example, Teflon® to avoid adhesion thereto of dispensing materials.

As shown in FIG. 2, which is a partial plan view and block diagram simplified illustration of system suitable for manufacture of a multi-colored three-dimensional multi-color object in accordance with another example. System 200 can be generally similar in construction to system 100 of FIG. 1 designed to support multicolored printing of 3D objects. Additionally to storage or material supply tank 102 of system 100, system 200 can also include one or more tanks 206/208 containing one or more types of coloring material 216/218 selected from a group of types of coloring materials including pigments, dyes, color particles and any other suitable type of coloring material in liquid, gel, beads or any other suitable form. Such materials, mixed with a colorless pseudoplastic material or gel can form a colored pseudoplastic material or gel. Color materials can be added in advance to form a pre-colored pseudoplastic material or gel or during a 3D object manufacturing process thus provided colored pseudoplastic material or gel online.

Additionally and optionally, materials 216/218 stored in one or more tanks 206/208 can include a pre-colored pseudoplastic material or gel.

Additionally and optionally, one or more tanks 206/208 can include materials having physical and chemical characteristics different than the physical and chemical characteristics of material 104 so that to include areas of variable physical properties in the finished product as will be explained in greater detail below.

Such material 216/218 can be selected from a group of materials including wax or wax mixtures, oil based materials, surface finish materials such as matte finish materials and any other suitable material.

System 200 can also include additional delivery tubing 206 and 208 that open into reception volume 202 of extrusion head 114 extrusion nozzle 116. Tanks 206/208 can include agitator-pumps (not shown) similar to agitator-pump 108.

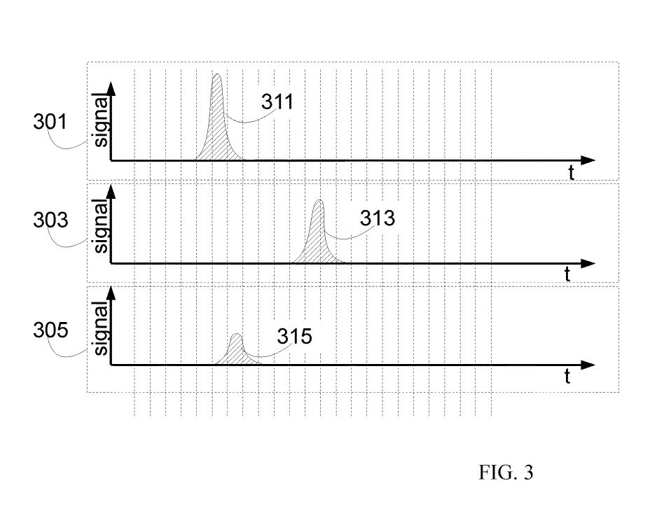

Reference is now made to FIG. 3, which is a partial plan view and block diagram simplified illustration of a system suitable for manufacture of a multi-colored three-dimensional multi-color object in accordance with yet another example. System 300 can be generally similar in construction to system 100 of FIG. 1. Extrusion head 114 can also house a bidirectional progressive cavity pump 302, the bi-directionality thereof indicated by an arrow designated reference numeral 350 that can cause material flow from inside reception volume 202 onto table 120 via nozzle 116, or alternatively, cause fluid to flow from outside extrusion head 114, such as from a tank 308 into reception volume 202 via same nozzle 202. Bidirectional pump 302 can be such as a ViscoTec RD-EC progressive cavity pump/dispenser commercially available from ViscoTec, Inc., P.O. Box 4091 Visalia, Calif. 93278, USA.

System 300 can also include one or more independent storage or material supply tanks 304/306/308 containing one or more types of coloring material 314/316/318 selected from a group of types of coloring materials or gels including pigments, dyes, color particles and any other suitable type of coloring material.

Alternatively, additionally and optionally, one or more tanks 304/306/308 can include materials each having physical and chemical characteristics different than the other or than the physical and chemical characteristics of material 104 so that to include areas of variable physical properties in the finished product as will be explained in greater detail below.

Such materials can be selected from a group of materials including wax or wax mixtures, oil based materials, surface finish materials such as matte finish materials and any other suitable material.

Coloring materials or gels 314/316/318 could include, for example, pigments with each pigment having a color different than that of the material or gel in another storage or material supply tank.

In system 300, extrusion head 114 Pump 302 controlled by computer 128 can be moved from a dispensing position, depicted in FIG. 3 by Roman numeral (I) to a drawing position depicted in FIG. 3 by Roman numeral (II). In this configuration, when extrusion head 114 nozzle 116 is in dispensing position (I), material or gel 312/314/316 can be dispensed via nozzle 116 to manufacture at least a portion of a 3D multi-colored 132. As will be explained in greater detail below, X-Y-Z movement system 124 (FIG. 1) controlled by computer 128 can move head 114 nozzle 116 from dispensing position (I) to drawing position (II) dipping nozzle 116 in at least one of storage or material supply tanks 302/304/306 drawing therefrom a quantity of respective coloring material or gel 312/314/316. The drawn quantity can be drawn through nozzle 116 into reception volume 202 to be later dispensed through nozzle 116 after X-Y-Z movement system 124 (FIG. 1) moves head 114 nozzle 116 back into dispensing position (I). Thus, in system 300, extrusion head 114 extrusion nozzle 116 draws material to be dispensed and extrudes the drawn material through the same opening.

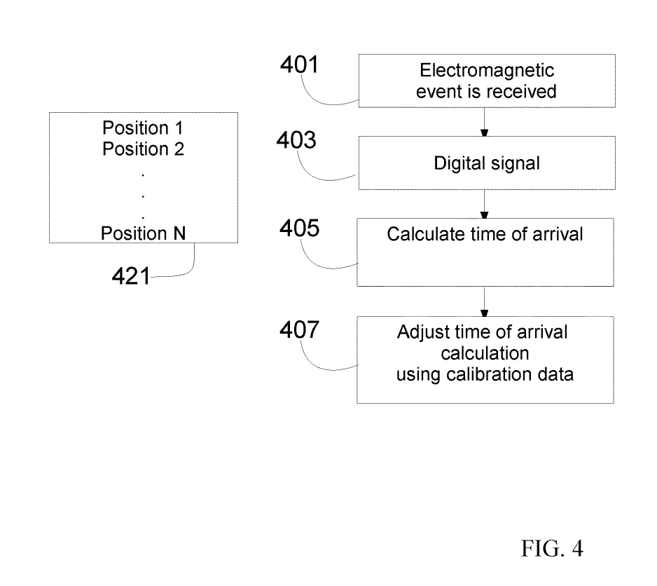

Referring now to FIGS. 4A, 4B, 4C and 4D collectively referred to as FIG. 4, which depict the implementation of system 300 of FIG. 3. The implementation of system 300 can be carried out by the following cycle of steps: one step, shown in FIG. 4A illustrates head 114 nozzle 116 in drawing position (II) with nozzle 116 dipped in at least one of storage or material supply tanks 302/304/306 such as, for example, storage or material supply tank 302. At this stage, pump 302 operating direction is reversed in a direction indicated by an arrow designated reference numeral 370 so that to draw a quantity of coloring material or gel 312 from storage or material supply tank 302. The drawn volume can enter reception volume 202 (FIG. 2), which has been evacuated by a same volume of material 104 concurrently drawn by pump 302 back into storage or material supply tank 102.

Once the desired quantity of coloring material or gel 312 has been drawn, X-Y-Z movement system 124 (FIG. 1) can move head 114 nozzle 116 back into dispensing position (I) as shown in FIG. 4B. When in position, pump 302 operating direction is reversed once again as indicated by an arrow designated reference numeral 390 and the quantity of coloring material or gel 312 previously drawn from storage or material supply tank 306 can be deposited in its entirety in one or more first layer 132-1 onto table 120 thus completing the second step. In this stage, the volume of dispensed coloring material or gel 312 reception volume 202 can be concurrently replaced by material or gel 104 drawn by pump 302 from storage or material supply tank 102.

The quantity of drawn coloring material or gel 312 can be calculated by computer 128 to be the exact quantity required to be deposited by head 114 nozzle 116 onto the 3D multi-colored 132 being manufactured. The quantity of material or gel 312 drawn from storage or material supply tank 306 is such so that it can be deposited in its entirety and any residual coloring material or gel 312 inside reception volume 202 (FIG. 2) is negligible.

At this point a third step can begin in which and as depicted in FIG. 4C, X-Y-Z movement system 124 (FIG. 1) can move head 114 nozzle 116 once again into drawing position (II) dipping nozzle 116 at least one other storage or material supply tank 302/304/306 such as, for example, storage or material supply tank 304. At this stage, pump 302 operating direction is reversed once again in a direction indicated by an arrow designated reference numeral 370 so that to draw a quantity of coloring material or gel 314 from storage or material supply tank 304. The drawn volume can enter reception volume 202 (FIG. 2), which has been evacuated by a same volume of material 104 concurrently drawn by pump 302 back into storage or material supply tank 102.

Once the desired quantity of coloring material or gel 314 has been drawn, X-Y-Z movement system 124 (FIG. 1) can move head 114 nozzle 116 back into dispensing position (I) as shown in FIG. 4D. When in position, pump 302 operating direction is reversed once again as indicated by an arrow designated reference numeral 390 and the quantity of coloring material or gel 314 previously drawn from storage or material supply tank 304 can be deposited in its entirety in one or more second layer 132-2 onto one or more first layer 132-1 thus completing the forth step. In this stage, the volume of dispensed coloring material or gel 312 reception volume 202 can be concurrently replaced by material or gel 104 drawn by pump 108 from storage or material supply tank 102.

This can be repeated as desired alternating between deposition of colorless material or gel 104 and any one or more coloring material or gel. The above described system and method simplify and reduce cost of manufacturing of multi-colored three-dimensional objects as well as allow online multi-color manufacturing and shortened throughput time.

Additionally and optionally, coloring materials 216/218/314/316/318 in one or more tanks 206/208/304/306/308 can be replaced with materials having physical and chemical characteristics different than the physical and chemical characteristics of material 104 so that to include areas of variable physical properties in the finished product. Such materials, having physical and chemical characteristics different than the physical and chemical characteristics of material 104, can be any type of material that would allow for easy and quick separation of layers so that to serve as a detachment layer separating between two abutting portions of a manufactured 3D object or between a manufactured 3D object and a support surface on which the object has been manufactured. Such materials can be selected, for example, from a group of materials including wax or wax mixtures, oil based materials, surface finish materials such as matte finish materials and any other suitable material.

One advantage of the system and method described above is in that materials of various color and/or physical and chemical characteristics can be drawn and extruded via extrusion head 114 nozzle 116 without cleaning the extrusion head and/or nozzle.

In another example shown in FIG. 5, which is a plan view of a dispensed 3D object, a 3D object 500 can be manufactured employing the above described system and method. A system such as system 300 (FIG. 3) can deposit one or more layers 502 initially on table 120 using a material physical and chemical characteristics different than the physical and chemical characteristics of material 104 (FIG. 1) such as a material including wax or wax mixtures or an oil based material. This can be followed by dispensing one or more layers of material 104 on top of one or more layers 502 and completing 3D object 500. The adherence properties of a material such as material 502 having waxy or oily characteristics are reduced thus supporting easy and rapid removal of 3D object 500 from table 120.

In yet another example shown in FIG. 6, which is a plan view of a partially dispensed 3D object, an incomplete 3D object 600 is a horse's head being manufactured employing the above described system and method. Similarly to the example of FIG. 5, a system such as system 300 (FIG. 3) can deposit one or more layers 602 initially on table 120 using a material physical and chemical characteristics different than the physical and chemical characteristics of material 104 (FIG. 1) such as a material including wax or wax mixtures or an oil based material. As described above, this can be followed by dispensing one or more layers of material 104 on top of one or more layers 502 and completing 3D object 500. The adherence properties of a material such as material 502 having waxy or oily characteristics are reduced thus supporting easy and rapid removal of 3D object 500 from table 120. Furthermore, to manufacture the 3D horse head, a support 550 must be deposited as well to support the horse's muzzle 504. the last layer to be deposited upon which will rest the to be printed layers of the horse's muzzle can also be printed from material 502 having waxy or oily characteristics thus supporting easy and rapid separation of the finished horse's muzzle from support 550.

It will be appreciated by persons skilled in the art that the present disclosure is not limited to what has been particularly shown and described hereinabove. Rather, the scope of the method and system includes both combinations and sub-combinations of various features described hereinabove as well as modifications and variations thereof which would occur to a person skilled in the art upon reading the foregoing description and which are not in the prior art.

1. System for manufacture of a multi-colored three-dimensional object, comprising:
at least one tank configured to store at least one material including a colorless pseudoplastic material, a coloring material and a pre-colored pseudoplastic material;
an extrusion head having an extrusion nozzle, the nozzle having at least one opening and configured to draw thereinto at least a quantity of the at least one material and extrude the drawn material in image-wise manner;
at least one bidirectional pump configured to deliver the colorless pseudoplastic material to the extrusion nozzle; and
an X-Y-Z movement system configured to move at least the extrusion nozzle in a three coordinate system;
wherein the extrusion nozzle draws and extrudes the material through the same opening.

2. The system according to claim 1, wherein the extrusion head houses the pump.

3. The system according to claim 1, wherein the extrusion nozzle also comprises a reception volume that communicates with a volume inside the extrusion head.

4. The system according to claim 3, wherein the reception volume supports reception of material from the volume in an extrusion head and/or material drawn from outside into the nozzle through an opening.

5. The system according to claim 1, wherein comprising at least two tanks configured to store materials each having physical and chemical characteristics different than the other.

6. The system according to claim 5, wherein an least one of the materials allows for easy and quick separation of layers so that to serve as a detachment layer separating between two abutting portions of the manufactured three-dimensional object or between the manufactured three-dimensional object and a support surface on which the object has been manufactured.

7. The system according to claim 5, wherein at least one the materials is a material selected from a group of materials including wax or wax mixtures, oil based materials and surface finish materials.

8. The system according to claim 1, wherein the coloring materials comprise one or more types of material selected from a group of types of coloring materials or gels including pigments, dyes and color particles.

9. Method for manufacture of a multi-colored three-dimensional object, comprising at least one cycle of steps comprising:
dipping an extrusion nozzle having at least one opening into at least one tank configured to store a colored or colorlessless pseudoplastic material at atmospheric pressure;
drawing a quantity of a pigmented or pigmentless pseudoplastic material into the extrusion nozzle via the at least one opening;
moving the extrusion nozzle to another location; and
extruding in image-wise manner the material via the same opening at a pressure exceeding the atmospheric pressure.

10. The method according to claim 9, wherein repeating the cycle of steps at least once without cleaning the extrusion head and/or nozzle.

11. Method for manufacture of a multi-colored three-dimensional object, comprising:
extruding through an extrusion nozzle a certain amount of a colorless pseudoplastic material at atmospheric pressure;
dipping the extrusion nozzle having at least one opening into at least one tank configured to store a colored pseudoplastic material at atmospheric pressure;
drawing a quantity of the colored pseudoplastic material into the extrusion nozzle via the at least one opening;
moving the extrusion nozzle to another location; and
extruding in image-wise manner the material via the same opening at a pressure exceeding the atmospheric pressure.

12. The method according to claim 11 wherein extruding in image-wise manner the colored material forms complementary portions of the same 3D object.

13. The method according to claim 11, wherein following extruding the colored pseudoplastic material extruding once again through the extrusion nozzle a certain amount of a colorless pseudoplastic material at atmospheric pressure without cleaning the extrusion head and/or nozzle between extrusions.
